(19) United States
(12) Patent Application Publication
(10) Pub. No.: US 2008/0313253 A1
(43) Pub. Date: Dec. 18, 2008

(54) OPERATION CIRCUIT FOR MODIFIED EUCLIDEAN ALGORITHM IN HIGH-SPEED REED-SOLOMON DECODER AND METHOD OF IMPLEMENTING THE MODIFIED EUCLIDEAN ALGORITHM

(75) Inventors: Jong-Yoon Shin, Daejeon (KR); Hanho Lee, Incheon (KR); Seungbeom Lee, Incheon (KR); Je Soo Ko, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignees: Electronics & Telecommunications Research Institute, Daejeon (KR); Inha University Industry Partnership Institute, Incheon (KR)

(21) Appl. No.: 12/051,503

(22) Filed: Mar. 19, 2008

(30) Foreign Application Priority Data
May 9, 2007 (KR) 2007-0045111

(51) Int. Cl. G06F 11/08

(52) U.S. Cl. 708/530

(57) ABSTRACT

Provided are an operation circuit for a modified Euclidean algorithm in a high-speed Reed-Solomon (RS) decoder and a method of implementing the modified Euclidean algorithm. Since a finite state machine (FSM) for generating a stop signal and an FSM for generating a control signal that controls a swap operation, a shift operation, and a polynomial operation for each basic cell of the modified Euclidean algorithm are used, an area-efficient RS decoder can be realized without using a conventional degree computation unit for comparing and calculating degrees.

### CROSS-REFERENCE TO RELATED PATENT APPLICATION

This application claims the benefit of Korean Patent Application No. 10-2007-0045111, filed on May 9, 2007, in the Korean Intellectual Property Office, the disclosure of which is incorporated herein in its entirety by reference.

### BACKGROUND OF THE INVENTION

1. Field of the Invention

The present invention relates to an operation circuit for a modified Euclidean algorithm in a high-speed Reed-Solomon (RS) decoder and a method of implementing the modified Euclidean algorithm.

This present invention is derived from a research project supported by the Information Technology (IT) Research & Development (R&D) program of the Ministry of Information and Communication (MIC) and the Institute for Information Technology Advancement (IITA) [2006-S-060-01, OTH-based 40G Multi-service Transmission Technology].

2. Description of the Related Art

Reed-Solomon (RS) code is a forward error correction (FEC) code used in a wide variety of applications such as magnetic storage media, optical storage media, wired communication, and satellite communication. RS code is typically expressed as RS(n,k,t), where n denotes the number of code symbols, k denotes the number of data symbols, t denotes the number of symbols whose error can be corrected, and t=(n-k)/2. Accordingly, in the case of a RS(255,239), t=8.

FIG. 1 is a block diagram of a conventional RS decoder.

Referring to FIG. 1, a syndrome polynomial computation (SC) block generates a syndrome polynomial S(x) and represents an error pattern of a received codeword. The syndrome polynomial S(x) is input to a key-equation solver (KES) block of the RS decoder. The KES block solves a key equation S(x)σ(x)=ω(x)mod x2t using any one of a Euclidean algorithm, a modified Euclidean algorithm, and a Berlecamp-Massay algorithm, which are for obtaining an error locator polynomial σ(x) and an error value polynomial ω(x).

Since the Euclidean algorithm is used to compute inverse elements of a Galois field, the Euclidean algorithm requires a look-up table (LUT) stored in a read-only memory (ROM). However, since the modified Euclidean algorithm does not require such LUT, the modified Euclidean algorithm can reduce a latency caused by the use of the LUT. Also, since the modified Euclidean algorithm can use a systolic-array structure, the modified Euclidean algorithm can faster and more easily pipeline blocks than the Berlecamp-Massay algorithm.

The polynomials σ (x) and ω(x) are input to a Chien search block and a Forney algorithm operation block to calculate locations and values of errors.

The modified Euclidean algorithm used in the KES block set initial values as shown in Equation 1 to obtain the error locator polynomial σ(x) and the error value polynomial ω(x) by erasing a highest degree term and iteratively reducing degrees. In Equation 1, S(x) denotes the aforesaid syndrome polynomial.

R₀(x)=x^{2t}, Q₀(x)=S(x), L₀(x)=0, U₀(x)=1 (1).

Equations 2 and 3 show values of polynomials Rᵢ(x), Qi(x), Lᵢ(x), and Uᵢ(x), which are to be recursively calculated i times. In Equations 2 and 3, aᵢ and bᵢ respectively denote coefficients of highest degree terms of the polynomials Rᵢ(x) and Qᵢ(x), and the values of the polynomials Rᵢ(x), Qᵢ(x), Lᵢ(x), and Uᵢ(x) are determined by the degrees of polynomials Rᵢ₋₁(x) and Qᵢ₋₁(x), wherein deg(Rᵢ(x)) and deg(Qᵢ(x)) respectively denote degrees of the polynomials Rᵢ(x) and Qᵢ(x). When deg(Rᵢ(x))<deg(Lᵢ(x)), the recursive operation stops, and the polynomials Rᵢ(x) and Lᵢ(x) at this time become an error value polynomial and an error locator polynomial, respectively.

$$\begin{matrix}{R}_{i} ( x ) = [ {σ}_{i - 1} {b}_{i - 1} {R}_{i - 1} ( x ) - {\overline{σ}}_{i - 1} {a}_{i - 1} {Q}_{i - 1} ( x ) ] - {x}^{\vert {l}_{i - 1} \vert} [ {σ}_{i - 1} {a}_{i - 1} {Q}_{i - 1} ( x ) - {\overline{σ}}_{i - 1} {b}_{i - 1} {R}_{i - 1} ( x ) ] \\ {Q}_{i} ( x ) = {σ}_{i - 1} {Q}_{i - 1} ( x ) - {\overline{σ}}_{i - 1} {R}_{i - 1} ( x ) . & ( 2 ) \\ {L}_{i} ( x ) = [ {σ}_{i - 1} {b}_{i - 1} {L}_{i - 1} ( x ) - {\overline{σ}}_{i - 1} {a}_{i - 1} {U}_{i - 1} ( x ) ] - {x}^{\vert {l}_{i - 1} \vert} [ {σ}_{i - 1} {a}_{i - 1} {U}_{i - 1} ( x ) - {\overline{σ}}_{i - 1} {b}_{i - 1} {L}_{i - 1} ( x ) ] \\ {U}_{i} ( x ) = {σ}_{i - 1} {U}_{i - 1} ( x ) - {\overline{σ}}_{i - 1} {L}_{i - 1} ( x ) . & ( 3 ) \\ {l}_{i - 1} = Deg ( {R}_{i - 1} ) - Deg ( {Q}_{i - 1} ) \\ {σ}_{i - 1} = \{ \begin{matrix}1 , & if {l}_{i - 1} \geq 0 \\ 0 , & if {l}_{i - 1} < 0.\end{matrix} & ( 4 ) \\ {R}_{0} ( x ) = {x}^{2 t} , {Q}_{0} ( x ) = xS ( x ) , {L}_{0} ( x ) = 0 , {U}_{0} ( x ) = x . & ( 5 )\end{matrix}$$

The modified Euclidean algorithm recursively solves Equation 2 through Equation 4, whereas a conventional method calculates degrees of the two polynomials Rᵢ₋₁(x) and Qᵢ₋₁(x) to obtain Iᵢ₋₁, of Equation 4 and generates a control signal to quickly solve Equations 2 and 3. The control signal includes a stop signal for stopping the recursive operation when deg(Rᵢ(x))<deg(Lᵢ(x)).

FIGS. 2A and 2B respectively illustrate a basic cell PE1 200 of a modified Euclidean algorithm for solving Equations 2 through Equation 4 and a conventional operation circuit in which basic cells are connected in a systolic-array fashion.

Initial values set as shown in Equation 5 are input to the basic cell PE1 200. If a degree deg(Rᵢ₋₁(x)) is equal to or greater than a degree deg(Qᵢ₋₁(x)), an arithmetic operation is performed and a switching signal becomes 0. If the degree deg(Rᵢ₋₁(x)) is less than the degree deg(Qᵢ₋₁(x)), however, the switching signal becomes 1. When the switching signal is 1, polynomials Rᵢ₋₁(x) and Qᵢ₋₁(x) are swapped, polynomials Lᵢ₋₁(x) and Uᵢ₋₁(x) are swapped, and the degrees deg(Rᵢ₋₁(x)) and deg(Qᵢ₋₁(x)) are swapped by a multiplexer. After arithmetic operations are performed, polynomials Rᵢ(x), Qᵢ(x), Lᵢ(x), and Uᵢ(x) are output from the multiplexer. If t errors are generated, polynomials R₂ₜ(x) and L₂ₜ(x) which are obtained by performing arithmetic operations on 2t cells become an error value polynomial and an error locator polynomial, respectively. If errors less than t errors are generated, that is, if a first coefficient of the polynomial Qᵢ(x) output from the multiplexer is 0, the polynomials Qᵢ(x) and Uᵢ(x) become an error value polynomial and an error locator polynomial, respectively, and operations are performed on 2t basic cells by comparing a degree deg(Qᵢ(x)), which is obtained using deg(Qᵢ(x))=deg(Qᵢ₋₁(x))-1, with t and then a shift operation is performed so that degrees of polynomials Q₂ₜ(x) and U₂ₜ(x) become t-1 and t, respectively.

FIG. 3 is a circuit diagram of a conventional operation circuit in which one basic cell is iteratively used by sending an output of the basic cell as an input in a systolic-array fashion.

When a clock latency, which is a time delay between an input of a basic cell to an output of the basic cell, is m, 2t-m registers are needed. Accordingly, the number of shift registers increases as the clock latency m decreases. When compared with the conventional operation circuit of FIG. 2B using 16 basic cells, the conventional operation circuit of FIG. 3 using one basic cell can considerably reduce a hardware area, but suffers from a high clock latency because the shift registers should be passed each time.

Since the conventional operation circuits of FIGS. 2 and 3 for the modified Euclidean algorithm comprise basic cells for implementing Equations 1 through 4, and each of the basic cells comprises a degree computation unit for calculating and comparing degrees of polynomials, the conventional operation circuits of FIGS. 2 and 3 are large.

FIG. 4 illustrates a conventional operation circuit for a degree computationless modified Euclidean algorithm. FIG. 5 illustrates operations performed on polynomials to generate control signals in the degree computationless modified Euclidean algorithm of FIG. 4.

The conventional operation circuit for the degree computationless modified Euclidean algorithm of FIG. 4 has an area-efficient architecture that requires a clock latency of 2t to obtain a final output, uses 3t+2 cells, and does not include a degree computation unit for calculating and comparing degrees. However, the conventional operation circuit of FIG. 4 has a low clock speed because it is difficult to pipeline blocks. In addition, the conventional operation circuit of FIG. 4 cannot process a new input until an error value polynomial and an error locator polynomial are obtained using outputs of the blocks after a clock latency of 2t. Accordingly, when the conventional operation circuit of FIG. 4 is applied to a 4-channel parallel structure sharing one KES block, a clock latency per syndrome calculation block is linearly increased.

### SUMMARY OF THE INVENTION

The present invention provides a high-speed area-efficient operation circuit for a modified Euclidean algorithm, which can efficiently process data streams and can easily pipeline blocks without using a degree computation unit which is included in a basic cell of a conventional operation circuit for a modified Euclidean algorithm, and a method of implementing the modified Euclidean algorithm.

According to an aspect of the present invention, there is provided an operation circuit for a modified Euclidean algorithm of a systolic-array structure comprising a plurality of basic cells in order to obtain an error value polynomial and an error locator polynomial on the basis of a syndrome polynomial, each of the basic cells comprising: a control signal generating unit generating a control signal for a swap operation and/or a shift operation, on the basis of a finite state machine (FSM) consisting of a function that determines whether a swap operation and/or a shift operation is performed on polynomials Cᵢ₋₁ and Dᵢ₋₁ on the basis of a value of the polynomial Cᵢ₋₁ and degrees of the polynomials Cᵢ₋₁ and Dᵢ₋₁; and an operation unit performing a swap operation or/and a shift operation and then a polynomial operation on polynomials Cᵢ₋₁, Dᵢ₋₁, Eᵢ₋₁, and Fᵢ₋₁ according to the control signal, wherein a polynomial C₀ input to a first basic cell among the basic cells is a value obtained by multiplying the syndrome polynomial by x, a polynomial D₀ input to the first basic cell is a value having a degree twice higher than the number of symbols whose errors can be corrected, a polynomial E₀ input to the first basic cell is x, a polynomial F₀ input to the first basic cell is 0, and even-numbered basic cells among the basic cells decrease degrees of output polynomials Cᵢ and Dᵢ by 1.

According to another aspect of the present invention, there is provided a method of implementing a modified Euclidean algorithm of a systolic-array structure comprising a plurality of basic cells in order to obtain an error value polynomial and an error locator polynomial on the basis of a syndrome polynomial, the method comprising: generating a control signal for a swap operation and/or a shift operation, on the basis of an FSM consisting of a function that determines whether a swap operation and/or a shift operation is performed on polynomials Cᵢ₋₁ and Dᵢ₋₁ on the basis of a value of the polynomial Cᵢ₋₁ and degrees of the polynomials Cᵢ₋₁ and Dᵢ₋₁; performing a swap operation or/and a shift operation and then a polynomial operation on polynomials Cᵢ₋₁, Dᵢ₋₁, Eᵢ₋₁, and Fᵢ₋₁ according to the control signal; and recursively performing the generating of the control signal and the performing of the operations, and decreasing by 1 degrees of polynomials Cᵢ and Dᵢ output as the operation results when performing operations on even-numbered basic cells, wherein a polynomial C₀ input to a first basic cell among the basic cells is a value obtained by multiplying the syndrome polynomial by x, a polynomial D₀ input to the first basic cell is a value having a degree twice higher than the number of symbols whose errors can be corrected, a polynomial E₀ input to the first basic cell is x, and a polynomial F₀ input to the first basic cell is 0.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional Reed-Solomon (RS) decoder;

FIG. 2A is a circuit diagram of a basic cell of a conventional modified Euclidean algorithm;

FIG. 2B illustrates a conventional operation circuit in which basic cells of FIG. 2A are connected in a systolic-array fashion;

FIG. 3 is a block diagram of a conventional operation circuit in which one basic cell is iteratively used by sending an output of a basic cell as an input in a systolic-array fashion;

FIG. 4 illustrates a conventional operation circuit for a degree computationless modified Euclidean algorithm;

FIG. 5 illustrates operations performed on polynomials to generate control signals in the degree computationless modified Euclidean algorithm of FIG. 4;

FIG. 6 is a circuit diagram of an operation circuit for a modified Euclidean algorithm according to an embodiment of the present invention;

FIG. 7 illustrates a finite state machine (FSM) for generating an operation control signal according to an embodiment of the present invention; and

FIG. 8 illustrates an FSM for generating a stop signal according to an embodiment of the present invention.

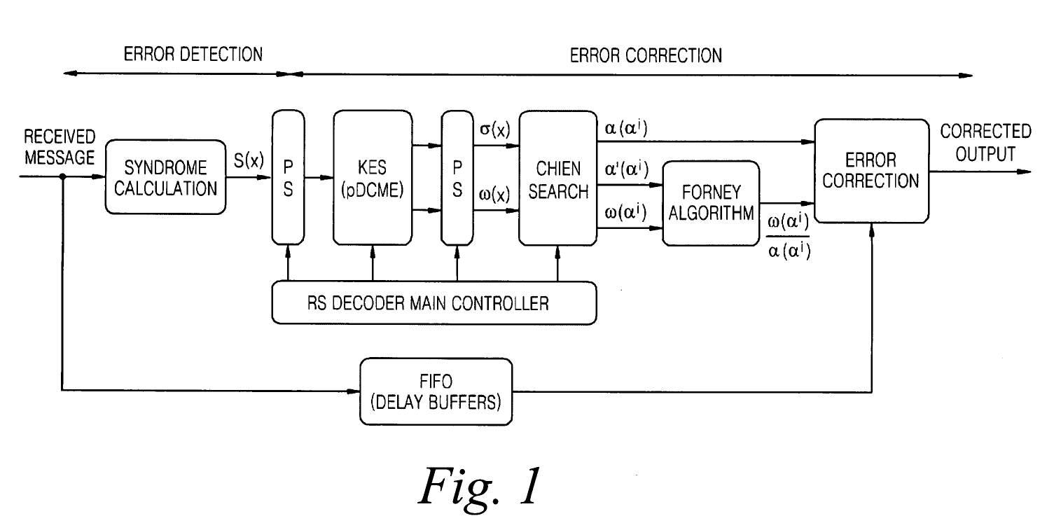

### DETAILED DESCRIPTION OF THE INVENTION

The present invention will now be described more fully with reference to the accompanying drawings, in which exemplary embodiments of the invention are shown.

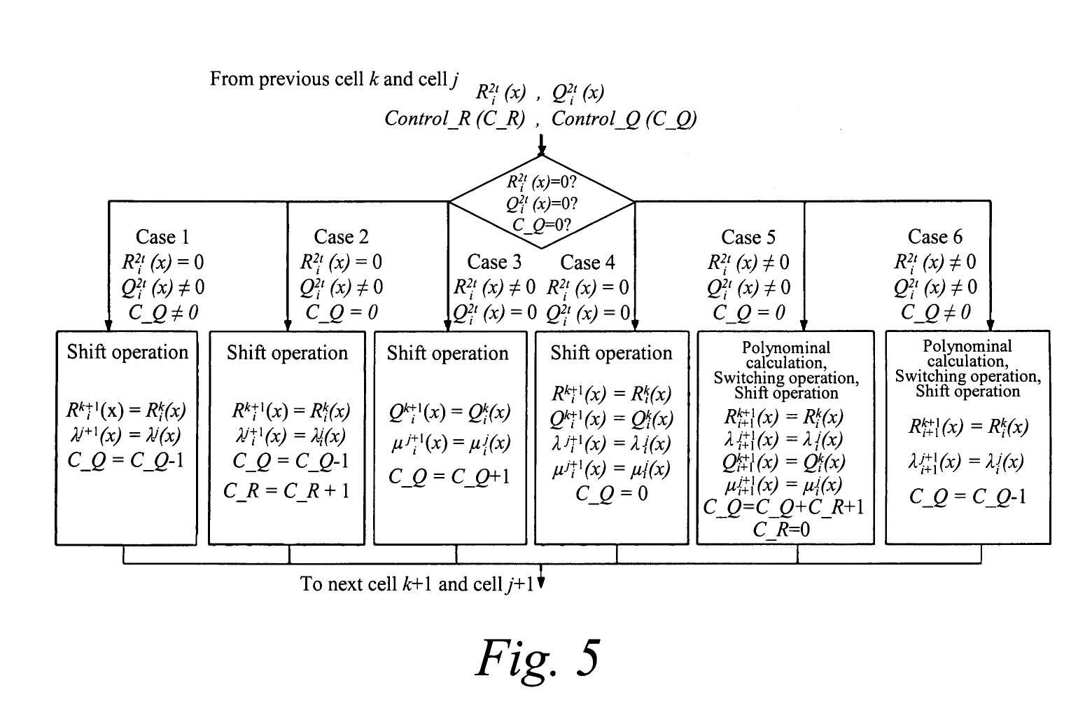

FIG. 6 is a circuit diagram of an operation circuit for a modified Euclidean algorithm according to an embodiment of the present invention.

In the present invention, Equations 2 through 4 are transformed into Equations 6 through 8 in order to remove a conventional degree computation unit for calculating and comparing degrees.

Rᵢ(x)=bᵢ₋₁Rᵢ₋₁(x)−x^{|l}ᵢ₋₁^{|}aᵢ₋₁Qᵢ₋₁(x)

Qᵢ(x)=Qᵢ₋₁(x) (6)

Rᵢ(x)=aᵢ₋₁Qᵢ₋₁(x)−x^{|l}ᵢ₋₁^{|}bᵢ₋₁Rᵢ₋₁(x)

Qᵢ(x)=Rᵢ₋₁(x) (7)

if(lₓ₋₁<0)SWAP(Rᵢ₋₁(x),Qᵢ₋₁(x))

Rᵢ(x)=bᵢ₋₁Rᵢ₋₁(x)−x^{|l}ᵢ₋₁^{|}aᵢ₋₁Qᵢ₋₁(x)

Qᵢ(x)=Qᵢ₋₁(x) (8)

if(lᵢ₋₁<0)SWAP(Rᵢ₋₁(x),Qᵢ₋₁(x))

Lᵢ(x)=bᵢ₋₁Lᵢ₋₁(x)−x^{|l}ᵢ₋₁^{|}aᵢ₋₁Uᵢ₋₁(x)

Uᵢ(x)=Uᵢ₋₁(x) (9)

When σ ᵢ₋₁ is 1, Equation 2 becomes Equation 6, and when σᵢ₋₁ is 0, Equation 2 becomes Equation 7. When Iᵢ₋₁ is a negative number and polynomials Rᵢ₋₁(x) and Qᵢ₋₁(x) are swapped in Equation 6, since a polynomial Rᵢ₋₁(x)new is the polynomial Qᵢ₋₁(x), a polynomial Qᵢ₋₁(x)new is the polynomial Rᵢ₋₁(x), a coefficient a_{i-1—}new is a coefficient bᵢ₋₁ of a highest degree term of the polynomial Qᵢ₋₁(x), and a coefficient b_{i-1—}new is a coefficient aᵢ₋₁ of a highest degree term of the polynomial Rᵢ₋₁(x), the same result is obtained as when the polynomials Rᵢ₋₁(x) and Qᵢ₋₁(x) are applied to Equation 7. That is, each of Equations 6 and 7 can be transformed into Equation 8 and Equation 9 can be transformed in the same manner.

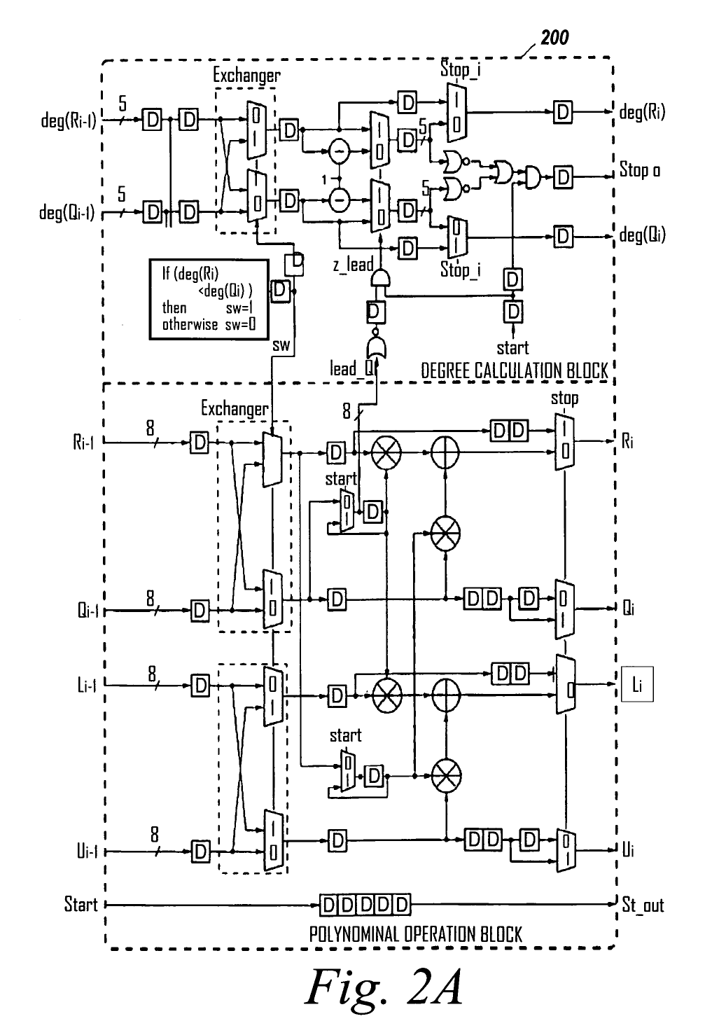

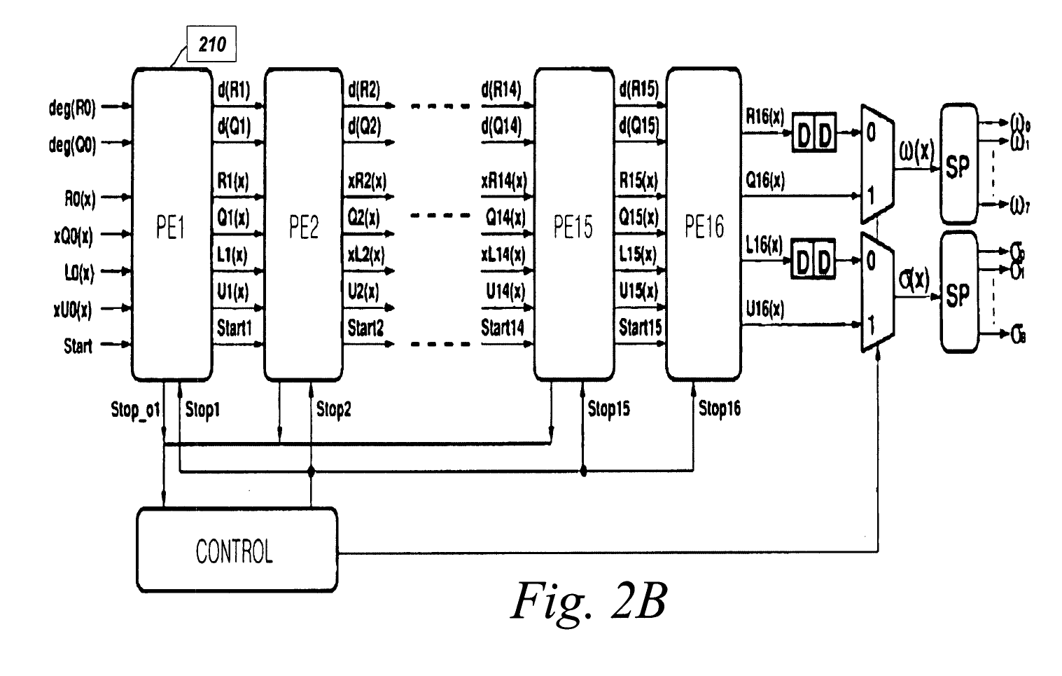

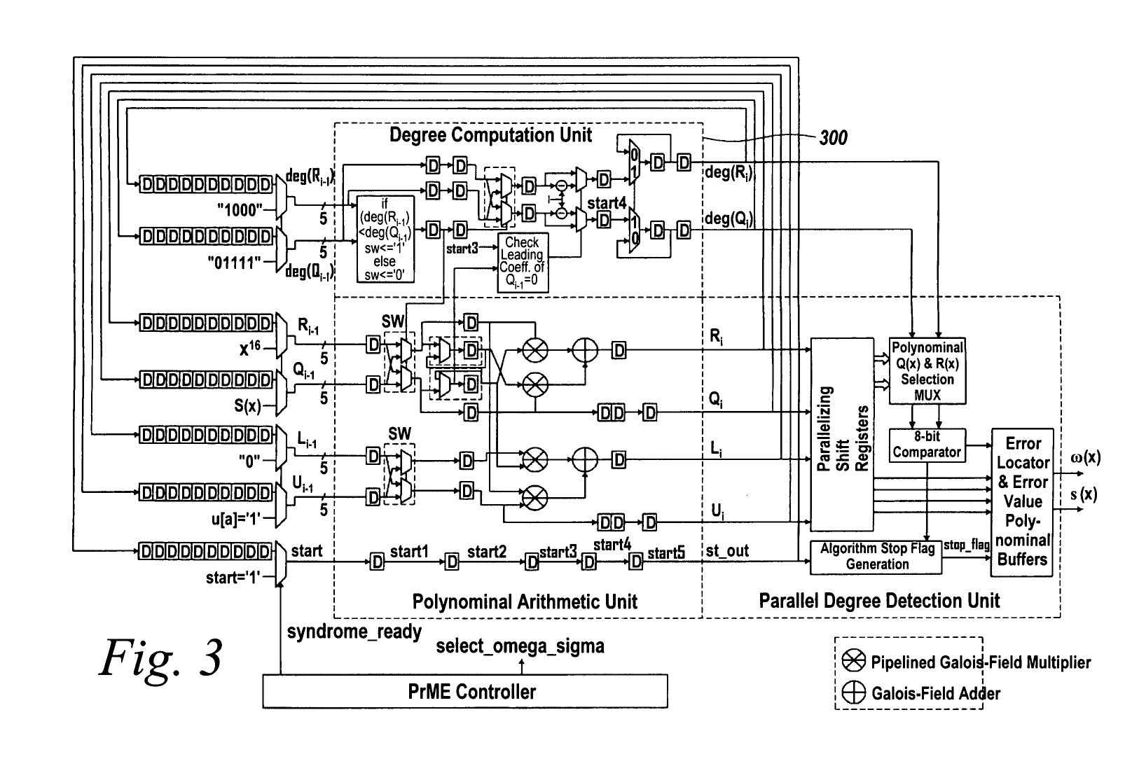

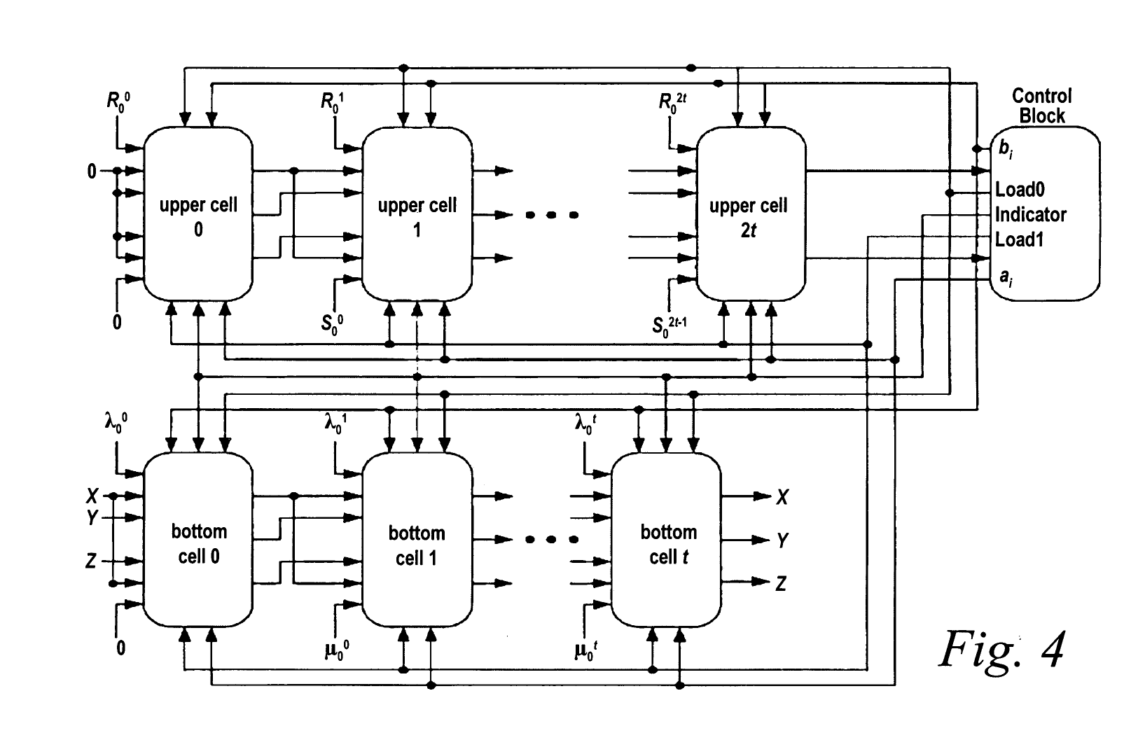

In FIG. 6, operations of Equation 8 performed on basic cells may include a shift operation, a polynomial operation, and a swap operation. That is, there are three control signals of the basic cells. The operation circuit of FIG. 6 is similar to a polynomial arithmetic block of FIG. 2A. In FIG. 6, a shift operation, which multiples data by x, and an arithmetic operation, which multiplies a coefficient of a highest degree term of a first input polynomial by a second input polynomial and a coefficient of a highest degree term of the second input polynomial by the first input polynomial and then adds the multiplication results, cannot be simultaneously performed on the basic cells, and a shift operation cannot be repeatedly performed on one basic cell two or more times.

A polynomial on which a shift operation is to be performed should be located at an output end of a multiplexer. Input patterns should be used in order to generate three control signals without using the number Iᵢ₋₁. Three input patterns are given by Equations 11 through 13.

$$\begin{matrix}{C}_{0} ( x ) = {xQ}_{0} ( x ) , {D}_{0} ( x ) = {R}_{0} ( x ) , {E}_{0} ( x ) = x , {F}_{0} ( x ) = 0 & ( 10 ) \\ {R}_{0} ( x ) = {x}^{2 t} \\ {Q}_{0} ( x ) = {S}_{2 t - 1} {x}^{2 t - 1} + {S}_{2 t - 2} {x}^{2 t - 2} + … {S}_{1} {x}^{1} + {S}_{0} \\ ( {S}_{i} \neq 0 , 0 \leq i \leq 2 t - 1 ) & ( 11 ) \\ {R}_{0} ( x ) = {x}^{2 t} \\ {Q}_{0} ( x ) = {S}_{2 t - 1} {x}^{2 t - 1} + {S}_{2 t - 2} {x}^{2 t - 2} + … {S}_{1} {x}^{1} + {S}_{0} \\ \{ \begin{matrix}{S}_{i} = 0 , & 2 t - 1 \cdot k \leq i \leq 2 t - 1 k \geq 0 , \\ {S}_{i} \neq 0 , & otherwise\end{matrix} & ( 12 )\end{matrix}$$

where k is an integer.

$${R}_{0} ( x ) = {x}^{2 t} \\ {Q}_{0} ( x ) = {S}_{2 t - 1} {x}^{2 t - 1} + {S}_{2 t - 2} {x}^{2 t - 2} + … {S}_{1} {x}^{1} + {S}_{0} \\ \{ \begin{matrix}{S}_{i} = 0 , & 2 t - 1 - m \leq i < 2 t - 1 , m > 0 , \\ {S}_{i} \neq 0 , & otherwise\end{matrix} \qquad ( 13 )$$

where m is an integer.

Since a degree of Q₀(x) is always less than a degree of R₀(x), a basic cell 1 of FIG. 6 has the input pattern given by Equation 10. Equation 11 shows the input pattern when a value of Sᵢ is not 0. This means that only a highest degree term of R₀(x) is removed from operations of Equation 8. That is, a degree of R₁(x) is equal to a degree of Q₁(x)(=Q₀(x))). R₂(x) and Q₂(x) can be obtained by using Equation 8. If R₂(x) is obtained by removing only the highest degree term of R₁(x), R₂(x) and Q₂(x) are swapped and the input pattern given by Equation 11 is obtained. If R₂(x) is obtained by removing not only the highest degree term but also the second highest degree term of R₁(x), R₂(x) and Q₂(x) are swapped and then the input pattern given by Equation 12 is obtained. A process in which a degree of Qᵢ(x) is greater than a degree of Rᵢ(x) while the highest degree term of Rᵢ(x) is removed and thus the two polynomials are swapped is referred to as a start of a new operation.

In FIG. 6, C₁(x) and D₁(x) respectively become R₁(x) and Q₁(x), C₂(x) and D₂(x) respectively become R₂(x) and Q₂(x). When a polynomial operation or a shift operation is performed, an output of Dᵢ(x) one clock later than an output of Cᵢ(x), such that x, which is multiplied to Qᵢ₋₁(x) for an addition in Equation 8, can be removed and a polynomial operation can be directly performed without a shift operation by multiplying Rᵢ₋₁(x) by x before Rᵢ₋₁(x) and Qᵢ₋₁(x) are swapped.

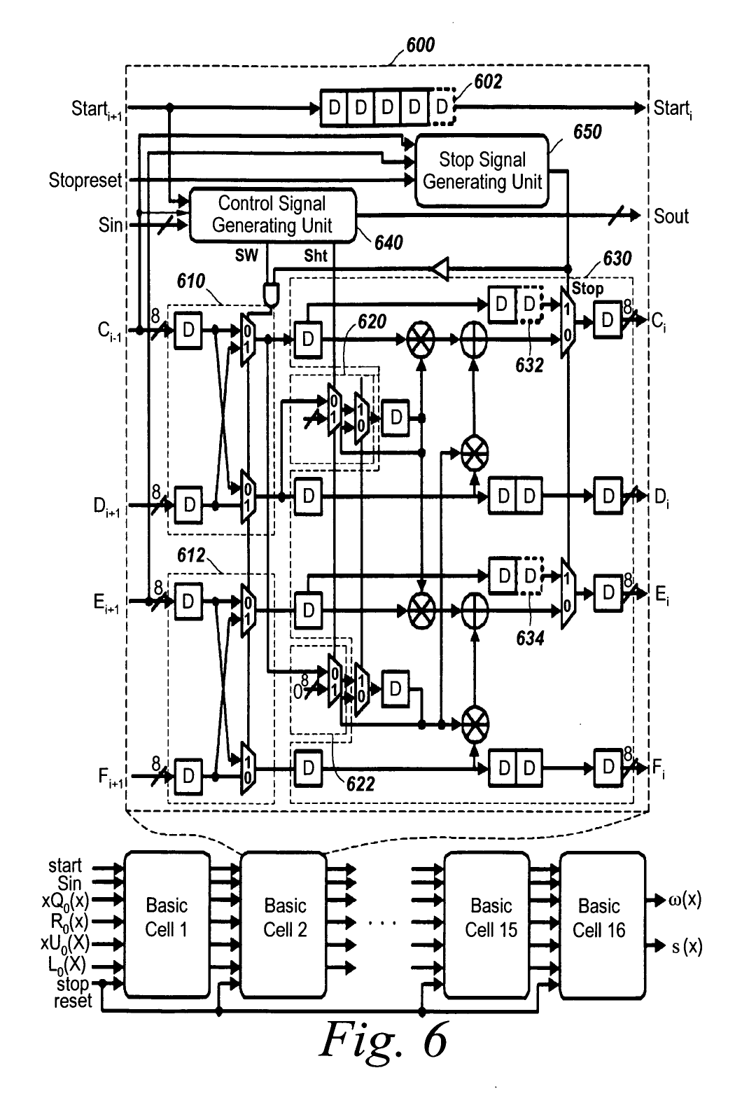

FIG. 7 illustrates a finite state machine (FSM) for generating an operation control signal. In FIG. 7, a state S0 denotes a state when an operation is initially performed or a new operation starts, and a control signal Sw and a control signal Sht for basic cells are output. When the control signal Sw is 1, a swap operation is performed, when the signal Sht is 1, a shift operation is performed, and when the signal Sht is 0, a polynomial operation s performed. The state S0 transits to a state S1 or a state S2 according to whether degrees of two input polynomials are equal to each other. An input signal Sl indicates whether the degrees of the two input signals are equal to each other. In the case of Equation 11, since degrees of two input polynomials are equal to each other, the input signal Sl becomes 1 and the state S0 transits to the state S1. In this case, since a polynomial operation is performed, the control signal Sht becomes 0, and since C₀(x) is xQ₀(x), the control signal Sw becomes 1 for the polynomial operation. If R₁(x) is obtained by removing only the highest degree term of R₀(x), a polynomial operation is performed, and the control signal when the input signal Sl is 1 in the state S1 of FIG. 7 is applied to a basic cell 2. If Rᵢ(x) is obtained by removing only the highest degree term of Rᵢ₋₁(x), the state in FIG. 7 repeatedly transits between the states S0 and S1.

In the case of the input pattern of Equation 12, since a degree of xQ₀(x) input to the basic cell 1 is less than a degree of R₀(x), an operation of multiplying xQ₀(x) by x is performed. Hence, when the input signal Sl is 0, the initial state S0 of FIG. 7 transits to a state S2, and a control signal for a shift operation is generated. If degrees of two input polynomials x2Q₀(x) and R₀(x) of the basic cell 2 are equal to each other, a polynomial operation is performed. If a degree of a polynomial, which is obtained by multiplying Q₁(x)(=Q₀(x)) by x, is equal to a degree of R₁(x), a polynomial operation is performed. If the degree of the polynomial, which is obtained by multiplying Q₁(x)(=Q₀(x)) by x, is not equal to the degree of R₁(x), however, it is determined whether degrees of R₁(x) and Q₁(x) are equal to each other. If it is determined that the degrees of R₁(x) and Q₁(x) are equal to each other, a polynomial operation is performed. If it is determined that the degrees of R₁(x) and Q₁(x) are not equal to each other, since the degree of R₁(x) is less than the degree of Q₁(x), a swap operation is performed. When k is 1, the state S0 transits to states S2, S3, S1, and S1.

In the case of the input pattern of Equation 13, the basic cell 1 becomes the same as in Equation 11. However, since a degree of R₁(x) is less than a degree of Q₁(x) in this case, a swap operation, instead of a polynomial operation, is performed on R₁(x) and Q₁(x). Since a swap operation and a polynomial operation can be simultaneously performed but a polynomial operation and a shift operation cannot be simultaneously performed, a shift operation is performed so that a polynomial operation is performed right before a swap operation is performed. Hence, when the input signal Sl is 0 in the state S1 of FIG. 7, a control signal for a shift operation is generated. After the operation for the basic cell 2 terminates, the state S0 is maintained.

The FSM of FIG. 7 is completed using the aforementioned rules and it is assumed that k<8. Accordingly, no error is generated in a state S16 during transmission through channels and when a syndrome value is 0. If t errors are generated, an error locator polynomial and an error value polynomial can be obtained after performing operations on 2t basic cells. However, if v(<t) errors are generated, an error locator polynomial and an error value polynomial can be obtained by performing operations on basic cells less than 2t basic cells. Considering that a degree of an error value polynomial is less than a degree of an error locator polynomial, a stop signal for stopping a polynomial operation is generated in an FSM.

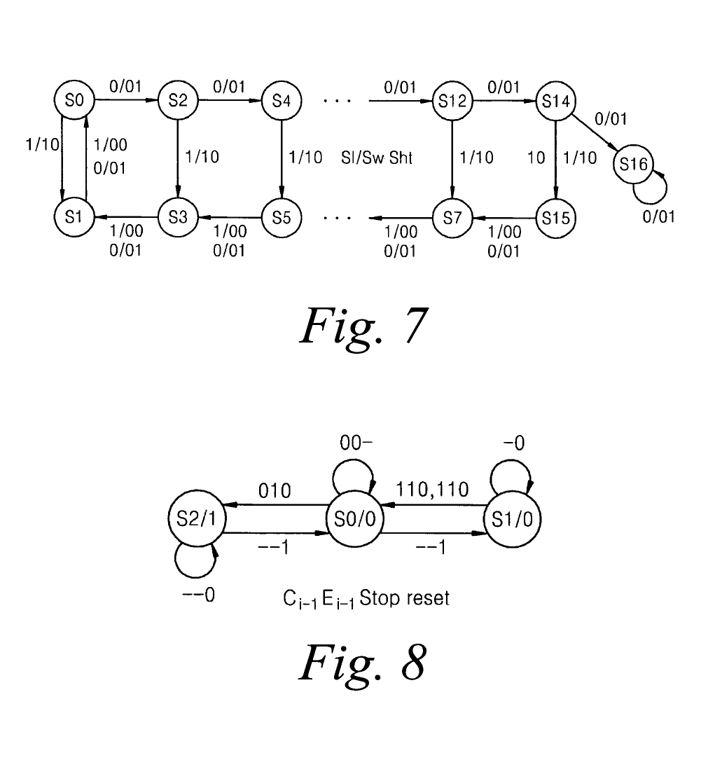

FIG. 8 illustrates an FSM for generating a stop signal, according to an embodiment of the present invention. In FIG. 8, it is determined what polynomial among Cᵢ₋₁(x) and Eᵢ₋₁(x) is first input with a value other than 0 to basic cells. If Eᵢ₋₁y(x) is first input to the basic cell, an initial state S0 transits to a state S2, and the state S2 is maintained until a stop reset signal is input. On the other hand, if Cᵢ₋₁(x) is first input to the basic cell or Eᵢ₋₁y(x) and Cᵢ₋₁(x) are simultaneously input to the basic cells, the initial state S0 transits to a state S1 and the state S1 is maintained until a stop reset signal is input.

A value of each of Cᵢ₋₁(x) and Eᵢ₋₁(x) is 0 or 1, and ‘−’ means that a corresponding input/output does not affect a state transition. If a stop signal becomes 1, only a shift operation is performed on the basic cells. However, there are things to additionally consider in order to guarantee that C₂ₜ(x) and E₂ₜ(x) have right values after operations are performed on 2t basic cells. For example, although outputs of a 6^{th} basic cell are an error value polynomial and an error locator polynomial, since one degree per two basic cells should be reduced in order that a degree of C₆(x) of the 6^{th} basic cell becomes 12 and a degree of C₂ₜ(x) becomes 7, registers 2 in even-numbered cells are removed.

Referring to FIG. 6, each basic cell 600 of the operation circuit for the modified Euclidean algorithm includes a swap operation unit 610, a shift operation unit 620, a polynomial operation unit 630, a control signal generating unit 640, and a stop signal generating unit 650.

The control signal generating unit 640 generates a control signal on the basis of the FSM of FIG. 7. In detail, the control signal generating unit 640 transits to a state on the basis of a state Sin received from a previous basic cell and a polynomial Cᵢ₋₁ output from the previous basic cell, and generates an operation control signal upon the state transition.

The stop signal generating unit 650 generates a stop signal on the basis of the FSM of FIG. 8. In detail, the stop signal generating unit 650 transits to a state on the basis of polynomials Cᵢ₋₁ and Dᵢ₋₁ output from a previous basic cell, and generates a stop signal. Once the stop signal is generated, outputs of the basic cell become an error locator polynomial and an error value polynomial.

The operation units 610, 620, and 630 perform operations according to the control signals of the control signal generating unit 640 and the stop signal generating unit 650, and particularly, even-numbered basic cells reduce degrees by removing registers 602, 632, and 634 marked by dotted lines in FIG. 6.

As described above, since a degree computation unit for comparing and calculating degrees, which is included in a basic cell of a conventional operation circuit for a modified Euclidean algorithm, is removed, in the present invention, data streams can be efficiently processed, blocks can be easily pipelined, and hardware complexity can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An operation circuit for a modified Euclidean algorithm of a systolic-array structure comprising a plurality of basic cells in order to obtain an error value polynomial and an error locator polynomial on the basis of a syndrome polynomial, each of the basic cells comprising:
a control signal generating unit generating a control signal for a swap operation and/or a shift operation, on the basis of a finite state machine (FSM) consisting of a function that determines whether a swap operation and/or a shift operation is performed on polynomials Cᵢ₋₁ and Dᵢ₋₁ on the basis of a value of the polynomial Cᵢ₋₁ and degrees of the polynomials Cᵢ₋₁ and Dᵢ₋₁; and
an operation unit performing a swap operation or/and a shift operation and then a polynomial operation on polynomials Cᵢ₋₁, Dᵢ₋₁, Eᵢ₋₁, and Fᵢ₋₁ according to the control signal,
wherein a polynomial C₀ input to a first basic cell among the basic cells is a value obtained by multiplying the syndrome polynomial by x, a polynomial D₀ input to the first basic cell is a value having a degree twice higher than the number of symbols whose errors can be corrected, a polynomial E₀ input to the first basic cell is x, a polynomial F₀ input to the first basic cell is 0, and even-numbered basic cells among the basic cells decrease degrees of output polynomials Cᵢ and Dᵢ by 1.

2. The operation circuit of claim 1, further comprising a stop signal generating unit generating a stop signal when a degree of the polynomial Cᵢ₋₁ is less than a degree of the polynomial Eᵢ₋₁, in an FSM indicating that a state transition occurs according to the degrees of the polynomials Cᵢ₋₁ and Eᵢ₋₁,
wherein, once the stop signal is generated, the basic cells output the output polynomials Cᵢ and Eᵢ as an error value polynomial and an error locator polynomial, respectively, and terminate the operations.

3. The operation circuit of claim 1, wherein the control signal generating unit transits a state according to a state of a previous basic cell and a value of the polynomial Cᵢ₋₁ and generates a corresponding control signal, on the basis of an FSM that specifies control signal generation conditions under which a control signal for a shift operation is generated if a value of the polynomial Cᵢ₋₁ is 0 and a control signal for a swap operation is generated if a value of the polynomial Cᵢ₋₁ is not 0 and degrees of the polynomials Cᵢ₋₁and Dᵢ₋₁ are equal to each other.

4. A method of implementing a modified Euclidean algorithm of a systolic-array structure comprising a plurality of basic cells in order to obtain an error value polynomial and an error locator polynomial on the basis of a syndrome polynomial, the method comprising:
generating a control signal for a swap operation and/or a shift operation, on the basis of an FSM consisting of a function that determines whether a swap operation and/or a shift operation is performed on polynomials Cᵢ₋₁ and Dᵢ₋₁ on the basis of a value of the polynomial Cᵢ₋₁ and degrees of the polynomials Cᵢ₋₁ and Dᵢ₋₁;
performing a swap operation or/and a shift operation and then a polynomial operation on polynomials Cᵢ₋₁, Dᵢ₋₁, Eᵢ₋₁, and Fᵢ₋₁ according to the control signal; and
recursively performing the generating of the control signal and the performing of the operations, and decreasing by 1 degrees of polynomials Cᵢ and Dᵢ output as the operation results when performing operations on even-numbered basic cells,
wherein a polynomial C₀ input to a first basic cell among the basic cells is a value obtained by multiplying the syndrome polynomial by x, a polynomial D₀ input to the first basic cell is a value having a degree twice higher than the number of symbols whose errors can be corrected, a polynomial E₀ input to the first basic cell is x, and a polynomial F₀ input to the first basic cell is 0.

5. The method of claim 4, further comprising:
generating a stop signal when a degree of the polynomial Cᵢ₋₁ is less than a degree of the polynomial Eᵢ₋₁, in an FSM indicating that a state transition occurs according to degrees of the polynomials Cᵢ₋₁and Eᵢ₋₁; and
once the stop signal is generated, terminating the operations and adjusting degrees of the polynomials in order to output the polynomials Cᵢ and Eᵢ as an error value polynomial and an error locator polynomial, respectively.

6. The method of claim 4, wherein the generating of the control signal comprises transiting a state according to a state of a previous basic cell and a value of the polynomial Cᵢ₋₁ and generating a corresponding control signal, on the basis of an FSM that specifies control signal generation conditions under which a control signal for a shift operation is generated if a value of the polynomial Cᵢ₋₁ is 0 and a control signal for a swap operation is generated if a value of the polynomial Cᵢ₋₁ is not 0 and degrees of the polynomials Cᵢ₋₁ and Dᵢ₋₁ are equal to each other.
